(19) United States
(12) Patent Application Publication
(10) Pub. No.: US 2015/0074002 A1
(43) Pub. Date: Mar. 12, 2015

(54) LAND VALUE DETERMINATION

(71) Applicant: Superior Edge, Inc., Mankato, MN (US)

(72) Inventor: Jerome Dale Johnson, Waterville, MN (US)

(73) Assignee: Superior Edge, Inc., Mankato, MN (US)

(21) Appl. No.: 14/021,736

(22) Filed: Sep. 9, 2013

(51) Int. Cl. G06Q 30/02; G06Q 50/02

(52) U.S. Cl. CPC G06Q 30/0278; G06Q 50/02
USPC 705/306

(57) ABSTRACT

In one example, a method includes receiving, by a parcel value analyzer and score generator (PVASG) executing on a computing device, data for a region of interest that includes a parcel of land. The data for the region of interest includes at least one of parcel data and logistics data. The method further includes determining, by the PVASG and based on the received data for the region of interest, a land value for the parcel of land included in the region of interest. The method further includes outputting, by the PVASG and in response to determining the land value for the parcel of land included in the region of interest, at least one report that includes an indication of the determined land value for the parcel of land.

### BACKGROUND

The present invention relates to computing devices, and more particularly to computing devices for use in determining a value of a parcel of land.

Determining an appropriate value for agricultural parcels of land is important for all the participants in a buying, selling, renting, and leasing transaction. This can help to ensure that there is a fair exchange between the participants. Interested parties may also include indirect participants such as lenders, appraisers, bankers, investors, trustees of estates, attorneys who create, update, and manage estates, accountants, and others who are responsible for taxes, trusts, and estates. Traditionally, available land valuation methods are limited to inexact approximations of value based upon, in most cases, recent sales and/or renting transactions of the land parcel at issue or similar or proximate land parcels, or based on the subjective opinions of the seller, purchaser, renter, or tenant.

Commonly, land valuation methods for agricultural parcels of land may also reflect historic production agriculture crop yields and commodity prices as they indicate potential achievable income from the parcel. These current methods to determine agricultural parcel values may be flawed due to the fact that they can be highly dependent on individual judgment rather than data and analysis of that data. Additionally, when turnover or sales of agricultural fields is low, it becomes difficult to compare the field at issue with other, similar parcels of land because there may be no similar parcels that have been sold or are available for sale that can be used for comparison.

Characteristics of the field, such as the soil, slope, location, and proximity to other relevant locations are all important factors in determining land value but often these characteristics are not consistently, objectively, or systematically used in a land value calculation. Also, historic crop yields are dependent on highly variable farming practices and external factors such as changing weather conditions, and so they are not necessarily reflected accurately in the determination of the value of the field. Furthermore, the importance of the location and proximity to other relevant locations is highly dependent on the total farming operation of an individual operator and so parcels of land can vary in value from one operator to another.

### SUMMARY

In one example, a method includes receiving, by a parcel value analyzer and score generator (PVASG) executing on a computing device, data for a region of interest that includes a parcel of land. The data for the region of interest includes at least one of parcel data and logistics data. The method further includes determining, by the PVASG and based on the received data for the region of interest, a land value for the parcel of land included in the region of interest. The method further includes outputting, by the PVASG and in response to determining the land value for the parcel of land included in the region of interest, at least one report that includes an indication of the determined land value for the parcel of land.

In another example, a system includes a computing device that includes at least one processor, and a parcel value analyzer and score generator (PVASG) executable by the at least one processor of the computing device. The PVASG is configured to receive data for a region of interest that includes a parcel of land. The data for the region of interest includes at least one of parcel data and logistics data. The PVASG is further configured to determine, based on the received data for the region of interest, a land value for the parcel of land included in the region of interest, and output, in response to determining the land value for the parcel of land included in the region of interest, at least one report that includes an indication of the determined land value for the parcel of land.

In another example, a computer-readable storage medium is encoded with instructions that, when executed, cause at least one processor of a computing device to receive data for a region of interest that includes a parcel of land. The data for the region of interest includes at least one of parcel data and logistics data. The computer-readable storage medium is further encoded with instructions that, when executed, cause the at least one processor of the computing device to determine, based on the received data for the region of interest, a land value for the parcel of land included in the region of interest, and output, in response to determining the land value for the parcel of land included in the region of interest, at least one report that includes an indication of the determined land value for the parcel of land.

In a further example, a method includes receiving, by a parcel value analyzer and score generator (PVASG) executing on a computing device, data associated with a parcel of land. The data associated with the parcel of land includes at least one of parcel data and logistics data. The method further includes determining, by the PVASG and based on the received data associated with the parcel of land, a real estate appraisal for the parcel of land. The method further includes outputting, by the PVASG and in response to determining the real estate appraisal for the parcel of land, at least one report that includes an indication of the determined real estate appraisal for the parcel of land.

In another example, a method includes receiving by a parcel value analyzer and score generator (PVASG) executing on a computing device, data for a region of interest that includes real estate. The data for the region of interest includes non-pecuniary data. The method further includes assigning, by the PVASG, a pecuniary value to the non-pecuniary data using a weighting of one or more factors associated with the non-pecuniary data, and outputting, by the PVASG, at least one report that includes an indication of the pecuniary value for the real estate.

### BRIEF DESCRIPTION OF THE DRAWINGS

FIG. 1 is a block diagram illustrating an example parcel value analysis and score system, in accordance with one or more aspects of this disclosure.

FIG. 2 is a block diagram illustrating further details of one example of a server device shown in FIG. 1.

FIG. 3 is a block diagram illustrating further examples of a database illustrated in FIG. 1.

FIG. 4 illustrates an example geographic information system (GIS) that can be used to determine a parcel value status.

FIG. 5 is a flow diagram illustrating example operations to determine a land value of a parcel of land and automatically output at least one report.

FIG. 6 is a flow diagram illustrating further details of the operations of FIG. 5.

FIG. 7 is a flow diagram illustrating further details of the operations of FIG. 5.

FIG. 8 illustrates an exemplary parcel valuation report.

FIG. 9 illustrates a table that represents an example scoring matrix for use in a method of determining a land value of a parcel of land within a region of interest.

FIG. 10 illustrates a table that represents another embodiment of an example scoring matrix for use in a method of determining a land value of a parcel of land within a region of interest.

FIG. 11 illustrates a table that represents example calculations that can be used to determine a land value of a parcel of land within a region of interest.

### DETAILED DESCRIPTION

According to techniques described herein, a computing device can combine, analyze, and process various types of data from various sources to determine a value of a parcel of land. The value may take the form of one or more of a score, a monetary (e.g., pecuniary) value, a non-pecuniary value, and a comparison of a score and/or monetary value to other scores and/or monetary values associated with the parcel and/or other parcels of land. The value of the parcel may be output (e.g., provided to the user) in a variety of ways and in a variety of formats. For example, the value of the parcel may be provided as one or more of a single overall score, a set of scores correlated to categories of information associated with the parcel, and a graphical representation of one or more scores and/or values associated with the parcel. Analyzing the characteristics of the parcel independent of, and yet acknowledging, previous and current farming practices can help to optimize an impartial valuation of the field. Likewise, analyzing a field based on its own characteristics, rather than on those of similar fields, can generate a more accurate valuation (e.g., real estate appraisal). Additionally, the location of the parcel (e.g., real estate) can impact the value of the parcel based on the prospective buyer/renter's resources and operation. Using impartial analytics techniques is important because no two parcels of land are exactly alike and not all farming practices result in optimal crop yields, and these variations can reduce the accuracy of the valuation. By analyzing multiple forms of data relating to a parcel of land, a system implementing techniques of this disclosure can determine a land value of a parcel of land, such as by rating, weighting, and ranking various data elements associated with the parcel of land, thereby providing a more accurate assessment (e.g., real estate appraisal) of the value of the parcel of land.

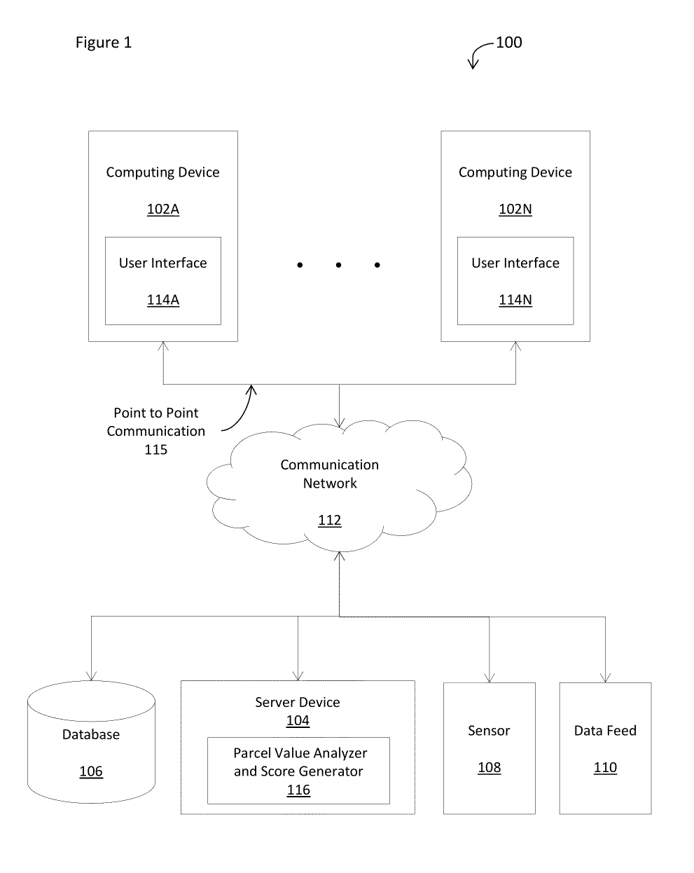

FIG. 1 is a block diagram illustrating an example parcel value analyzer and score system 100, in accordance with one or more aspects of this disclosure. As illustrated in FIG. 1, parcel value analyzer and score system 100 can include computing devices 102A-102N (collectively referred to herein as “computing devices 102”), server device 104, database 106, sensor 108, data feed 110, and communication network 112. Each of computing devices 102 can include a user interface, illustrated in FIG. 1 as user interfaces 114A-114N, and collectively referred to herein as “user interfaces 114.” Server device 104 can include parcel value analyzer and score generator 116.

While illustrated with respect to computing devices 102A-102N, computing devices 102 can include any number of computing devices, such as one computing device 102, two computing devices 102, five computing devices 102, fifty computing devices 102, or other numbers of computing devices 102. Examples of computing devices 102 can include, but are not limited to, portable or mobile devices such as mobile phones (including smartphones), laptop computers, tablet computers, desktop computers, personal digital assistants (PDAs), servers, mainframes, or other computing devices.

Computing devices 102, in certain examples, can include user interfaces 114. For example, computing device 102A can include user interface 114A, executable by one or more processors of computing device 102A, that can enable a user to interact with computing device 102A and parcel value analyzer and score system 100 via one or more input devices of computing device 102A (e.g., a keyboard, a mouse, a microphone, a camera device, a presence-sensitive and/or touch-sensitive display, or one or more other input devices). User interfaces 114 can be configured to receive input (e.g., in the form of user input, a document or file, or other types of input) and provide an indication of the received input to one or more components of parcel value analyzer and score system 100 via communication network 112.

As illustrated in the example of FIG. 1, communication network 112 communicatively couples components of parcel value analyzer and score system 100. Examples of communication network 112 can include wired or wireless networks or both, such as local area networks (LANs), wireless local area networks (WLANs), cellular networks, wide area networks (WANs) such as the Internet, or other types of networks. Although the example of FIG. 1 is illustrated as including one communication network 112, in certain examples, communication network 112 may include multiple communication networks. In addition, as illustrated in FIG. 1, one or more of computing devices 102 can communicate with one another via point-to-point communications 115.

Database 106 can include one or more databases configured to store data related to parcel value determination. For instance, database 106 can include one or more relational databases, hierarchical databases, object-oriented databases, multi-dimensional databases, or other types of databases configured to store data usable by parcel value analyzer and score system 100 to determine a land value of a parcel of land within a region of interest. As an example, and as further described herein, database 106 can include one or more databases configured to store parcel data, meteorological data, local knowledge data, geographic data, production history data, risk profile data, premium crop opportunity data, landlord data, investment profile data, soils data, drainage data, improvements data, logistics data, configuration data, or other types of data that are retrievable by parcel value analyzer and score generator 116 to determine a current land value of the parcel of land.

Sensor 108 can include one or more sensors capable of gathering data usable by parcel value analyzer and score system 100. For instance, sensor 108 can include one or more of a remote sensor (e.g., a sensor that is physically remote from the region of interest) and an in-field sensor (e.g., a sensor that is physically proximate and/or within the region of interest). As one example, sensor 108 can include an image sensor, such as an image sensor included within a camera device (e.g., a visible-spectrum image sensor, an ultra-violet (UV) image sensor, an infra-red image sensor such as included in a thermal imaging camera, a hyperspectral image sensor, or other types of image sensors) and configured to gather image data for a region of interest. Such image data can include, but is not limited to, crop color data (e.g., traditional, red, infrared, green, blue), pattern data, tone data, texture data, shape data, and shadow data.

In certain examples, sensor 108 can include one or more other sensors, such as precipitation sensors (e.g., a rain gauge), light sensors, wind sensors, or other types of sensors. In some examples, sensor 108 can include one or more remote sensors carried by, for example, a remotely piloted vehicle (RPV), an unmanned aerial vehicle (UAV), an aircraft, a satellite, etc. For instance, sensor 108 may include one or more image sensors included within a camera device carried by an RPV and configured to capture image data for a region of interest (e.g., a field, a portion of a field, a region including a field and its surrounding area, and the like). Such RPVs can be convenient vehicles for obtaining in-season data related to crop condition due in part to their ability to gather data in a timely, quick, scalable, and economical manner.

As illustrated in FIG. 1, one or more components of parcel value analyzer and score system 100 can be configured to receive data from data feed 110 (e.g., via communication network 112, point-to-point communications 115, etc.). Examples of data received by components of parcel value analyzer and score system 100 from data feed 110 can include vegetation data, weather data (e.g., temperature data, average temperature data, data indicating events such as thunderstorms, floods, hail, wind storms, etc.), climate data, or other types of data. Data feed 115 may provide data to components of parcel value analyzer and score system 100 via various sources, such as commercial, governmental, and public data sources. For instance, such sources can include Internet-based sources, such as the United States Department of Agriculture, the National Oceanic and Atmospheric Administration, the Risk Management Agency (RMA), or other public and/or private data sources. As another example, data feed 110 can provide data to components of parcel value analyzer and score system 100 from sources such as academic and/or research organizations, suppliers of crop inputs, buyers of crops, and peer farmers. In some examples, data feed 110 can provide information obtained from a social networking service, such that data feed 110 can provide components of parcel value analyzer and score system 100 with information obtained from peer farmers and/or other computing systems.

As illustrated in the example of FIG. 1, parcel value analyzer and score system 100 can include server device 104. In certain examples, server device 104 can be substantially similar to computing devices 102, in that server device 104 can be a computing device including one or more processors capable of executing computer-readable instructions stored within memory of server device 104 that, when executed, cause server device 104 to implement functionality according to techniques described herein. For instance, server device 104 can be a portable or non-portable computing device, such as a server computer, a mainframe computer, a desktop computer, a laptop computer, a tablet computer, a smartphone, or other type of computing device. In some examples, although illustrated in FIG. 1 as including one server device 104, parcel value analyzer and score system 100 can include multiple server devices 104. For instance, in certain examples parcel value analyzer and score system 100 can include multiple server devices 104 that distribute functionality attributed to server device 104 among the multiple server devices.

As illustrated, server device 104 can include parcel value analyzer and score generator (PVASG) 116. PVASG 116 can include any combination of software and/or hardware executable by one or more server devices 104 to determine a land value of a parcel of land according to techniques described herein. As an example, PVASG 116 can receive data for a region of interest, such as a region of interest that includes a parcel of land. For instance, PVASG 116 can receive data from one or more of computing devices 102 (e.g., via user interfaces 114), database 106, sensor 108, and data feed 110 via communication network 112, point-to-point communications 115, and the like. The received data can include data usable by PVASG 116 to determine a land value of a parcel of land within the region of interest. For example, PVASG 116 can receive one or more of parcel data, meteorological data, local knowledge data, geographic data, production history data, risk profile data, premium crop opportunity data, landlord data, investment profile data, soils data, drainage data, improvements data, logistics data, configuration data, or other types of data.

A land value of a parcel of land can reflect and/or include an indication of at least one of a size and shape value, a soils value, an improvements value, a drainage value, a production history value, a risk profile value, a logistics value, a premium crops value, and a landlord value within the region of interest. In some examples, a land value of the parcel of land determined by PVASG 116 can be considered a real estate appraisal of the parcel of land, such as a real estate appraisal that reflects a monetary market value of the parcel of land. In certain examples, recognizing that land can be sold in relation to the Public Land Survey System (PLSS), PVASG 116 can determine the land value of the parcel of land using a township/range/section measurement system. In other examples, PVASG 116 can determine the land value of the parcel of land using a plat system, a metes and bounds system, or other such surveying system.

In response to determining a land value of the parcel of land, PVASG 116 can output at least one report. For instance, PVASG 116 can output the at least one report including one or more email messages, short messaging service (SMS) messages, voice messages, voicemail messages, audible messages, or other types of messages that include an indication of the at least one report. In certain examples, PVASG 116 can output a report to user interfaces 114 (e.g., via communication network 112). In some examples, PVASG 116 can determine a distribution list, such as a list of accounts associated with parcel value analyzer and score system 100 (e.g., user accounts, accounts associated with one or more other computing systems, etc.), and can output the at least one report to the list of accounts.

In certain examples, parcel value analyzer and score system 100 can include one or more components not illustrated in FIG. 1. For instance, as discussed above, parcel value analyzer and score system 100 can include, in some examples, multiple server devices 104 that distribute functionality of server device 104 among the multiple server devices 104. Similarly, one or more illustrated components of parcel value analyzer and score system 100 may not be present in each embodiment of parcel value analyzer and score system 100. For instance, in certain examples, at least one computing device 102 and server device 104 may comprise a common device. For example, server device 104 and computing device 102 can, in some examples, be one device that executes both PVASG 116 and user interface 114.

As one example operation of parcel value analyzer and score system 100 of FIG. 1, PVASG 116, executing on one or more processors of server device 104, can receive data for a region of interest, such as a region of interest that includes a parcel of land (e.g., real estate including a parcel of agricultural land). The data for the region of interest can include one or more of pecuniary (e.g., monetary) and non-pecuniary data. Non-limiting examples of pecuniary data can include data associated with past sales of the parcel of land, data associated with sales of comparable parcels of land (e.g., geographically comparable, comparable in size, shape, etc.), or other types of pecuniary data. Examples of non-pecuniary data can include, but are not limited to, meteorological data, local knowledge data, non-pecuniary geographic data, landlord data, soils data, drainage data, improvements data, logistics data, or other types of non-pecuniary data.

PVASG 116 can receive, in some examples, the data for the region of interest from one or more of database 106, sensor 108, data feed 110, and computing devices 102 via communication network 112. PVASG 116 can determine, based on the received data for the region of interest, a land value for a parcel of land within the region of interest. PVASG 116 can output, in response to determining land value of the parcel of land, at least one report. For instance, PVASG 116 can output one or more reports to one or more of computing devices 102, such one or more reports that are output to one or more of user interfaces 114, one or more email messages, voice messages, voicemail messages, text messages, SMS messages, or other types of reports. In certain examples, the one or more reports can include at least one of an indication of the land value of the parcel of land and a degree by which the land value deviates from land values of similar parcels of land (e.g., parcel values determined with respect to other parcels of land).

In this way, PVASG 116 can dynamically analyze multiple forms of data received from multiple input sources to determine a land value of a parcel of land within a region of interest. PVASG 116 can automatically output at least one report in response to the determination. Accordingly, PVASG 116 can output timely reports regarding parcel value that may enable a user, such as a farmer, to more accurately assess the value of a parcel of land. Moreover, by analyzing multiple forms of data, PVASG 116 can increase the accuracy of the determination of the land value of the parcel of land, thereby possibly enabling a more accurate leasing or purchasing agreement.

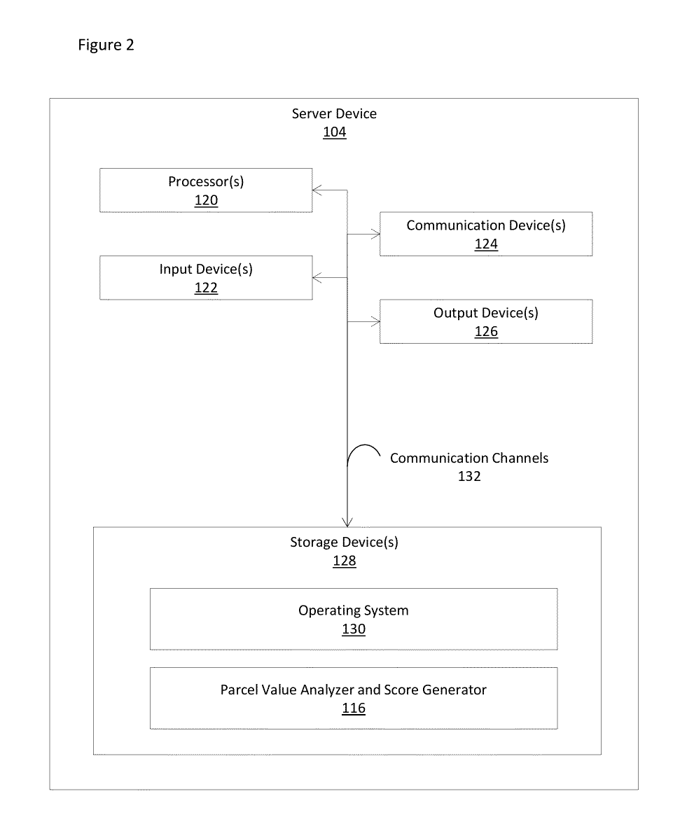

FIG. 2 is a block diagram illustrating further details of one example of server device 104 shown in FIG. 1, in accordance with one or more aspects of this disclosure. FIG. 2 illustrates only one example of server device 104, and many other examples of server device 104 can be used in other examples.

As shown in the example of FIG. 2, server device 104 can include one or more processors 120, one or more input devices 122, one or more communication devices 124, one or more output devices 126, and one or more storage devices 128. As illustrated, server device 104 can include operating system 130 and PVASG 116 that are executable by server device 104 (e.g., by one or more processors 120).

Each of components 120, 122, 124, 126, and 128 can be interconnected (physically, communicatively, and/or operatively) for inter-component communications. In some examples, communication channels 132 can include a system bus, a network connection, an inter-process communication data structure, or any other method for communicating data. As illustrated, components 120, 122, 124, 126, and 128 can be coupled by one or more communication channels 132. Operating system 130 and PVASG 116 can also communicate information with one another as well as with other components of server device 104, such as output devices 126.

Processors 120, in one example, are configured to implement functionality and/or process instructions for execution within server device 104. For instance, processors 120 can be capable of processing instructions stored in storage device 128. Examples of processors 120 can include any one or more of a microprocessor, a controller, a digital signal processor (DSP), an application specific integrated circuit (ASIC), a field-programmable gate array (FPGA), or other equivalent discrete or integrated logic circuitry.

One or more storage devices 128 can be configured to store information within server device 104 during operation. Storage device 128, in some examples, is described as a computer-readable storage medium. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, storage device 128 is a temporary memory, meaning that a primary purpose of storage device 128 is not long-term storage. Storage device 128, in some examples, is described as a volatile memory, meaning that storage device 128 does not maintain stored contents when power to server device 104 is turned off. Examples of volatile memories can include random access memories (RAM), dynamic random access memories (DRAM), static random access memories (SRAM), and other forms of volatile memories. In some examples, storage device 128 is used to store program instructions for execution by processors 120. Storage device 128, in one example, is used by software or applications running on server device 104 (e.g., PVASG 116) to temporarily store information during program execution.

Storage devices 128, in some examples, also include one or more computer-readable storage media. Storage devices 128 can be configured to store larger amounts of information than volatile memory. Storage devices 128 can further be configured for long-term storage of information. In some examples, storage devices 128 include non-volatile storage elements. Examples of such non-volatile storage elements can include magnetic hard discs, optical discs, floppy discs, flash memories, or forms of electrically programmable memories (EPROM) or electrically erasable and programmable (EEPROM) memories.

Server device 104, in some examples, also includes one or more communication devices 124. Server device 104, in one example, utilizes communication device 124 to communicate with external devices via one or more networks, such as one or more wireless networks. Communication device 124 can be a network interface card, such as an Ethernet card, an optical transceiver, a radio frequency transceiver, or any other type of device that can send and receive information. Other examples of such network interfaces can include Bluetooth, 3G, 4G, and WiFi radio computing devices as well as Universal Serial Bus (USB). In some examples, server device 104 can utilize communication device 124 to wirelessly communicate with an external device, such as one or more sensors 108 (illustrated in FIG. 1).

Server device 104, in one example, also includes one or more input devices 122. Input device 122, in some examples, is configured to receive input from a user. Examples of input device 122 can include a mouse, a keyboard, a microphone, a camera device, a presence-sensitive and/or touch-sensitive display, or other type of device configured to receive input from a user.

One or more output devices 126 can be configured to provide output to a user. Examples of output device 126 can include a display device, a sound card, a video graphics card, a speaker, a cathode ray tube (CRT) monitor, a liquid crystal display (LCD), or other type of device for outputting information in a form understandable to users or machines.

Server device 104 can include operating system 130. Operating system 130 can, in some examples, control the operation of components of server device 104. For example, operating system 130, in one example, facilitates the communication of PVASG 116 with processors 120, input devices 122, communication devices 124, and/or output devices 126.

PVASG 116 can include program instructions and/or data that are executable by server device 104 to perform one or more of the operations and actions described in the present disclosure. For instance, PVASG 116 can receive data for a region of interest from one or more of communication devices 124 (e.g., from a remote device, such as from one or more of computing devices 102, sensor 108, data feed 110, and/or database 106) and input devices 122 (e.g., a mouse, keyboard, or other input devices). PVASG 116, executing on one or more processors 120, can determine, based on the received data for the region of interest, a land value for a parcel of land within the region of interest. For instance, PVASG 116 can determine a parcel value score for parcel of land within the region of interest based on received data, such as parcel data, meteorological data, local knowledge data, geographic data, production history data, risk profile data, premium crop opportunity data, landlord data, investment profile data, soils data, drainage data, improvements data, logistics data, configuration data, or other types of data, as is further described herein. PVASG 116 can output, in response to determining the parcel value score at least one report. For instance, PVASG 116 can output at least one report via one or more of output devices 126 (e.g., a displayed report, an audible report, or other types of report) and communication devices 124 (e.g., via communication network 112 to computing devices 102).

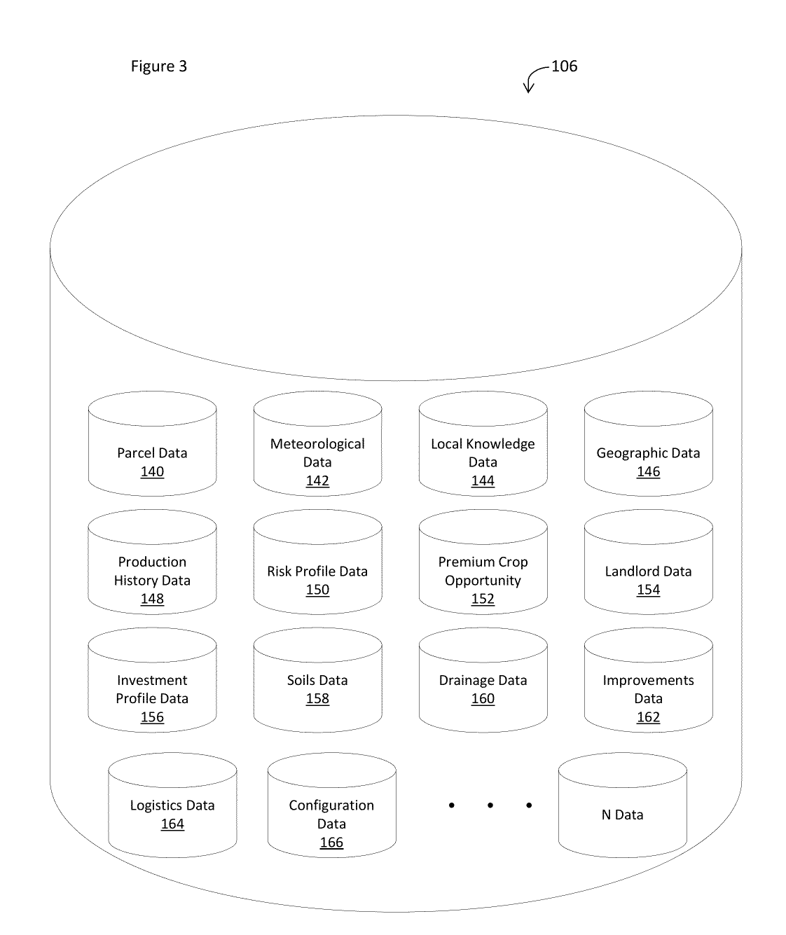

FIG. 3 is a block diagram illustrating further examples of database 106 illustrated in FIG. 1, in accordance with one or more aspects of this disclosure. As illustrated, database 106 can include parcel data 140, meteorological data 142, local knowledge data 144, geographic data 146, production history data 148, risk profile data 150, premium crop opportunity data 152, landlord data 154, investment profile data 156, soils data 158, drainage data 160, improvements data 162, logistics data 164, and configuration data 166. In some examples, as is illustrated in FIG. 3 by including “N Data”, database 106 can include one or more types of data that are not illustrated in FIG. 3. That is, the illustration of element “N Data” indicates that data included within database 106 is not limited to the illustrated categories, but may include one or more categories not illustrated in FIG. 3. Similarly, in certain examples, database 106 can include fewer data and/or data categories than are illustrated in FIG. 3. For instance, in some examples, database 106 can include one, two, three, five, or other numbers of data categories, and may not include each of the categories illustrated in FIG. 3. In certain examples, data can be present within database 106 in multiple forms and/or combinations. For instance, in some examples, data can be included in multiple categories of data. In some examples, data can be present within one or more of the categories and represented by multiple forms within the one or more categories.

Parcel data 140 can include data corresponding to, for example, parcel locations and the shape and size of the parcel, the proximity of the parcel to other relevant locations such as other parcels managed and operated by the user. Parcel data 140 can, in certain examples, also include parcel data for the fields of other farmers (e.g., received via a social network or other such method), such as crop quality problems on a nearby field operated by another farmer. In some examples, parcel data 140 can include data associated with characteristics of the parcel, such as topographical information and other non-crop vegetation on the parcel. Parcel data 140 can include data associated with crop conditions over a growing season, such as determined through various sensing methods (e.g., remotely piloted vehicles (RPVs), in-field sensors, and the like). In certain examples, parcel data 140 can include data associated with previously performed analyses and determinations of parcel value. On some occasions, parcel data 104 may include data associated with areas of land proximate to the parcel to be excluded from analysis.

Meteorological data 142 can include data associated with trends in weather and/or climate data for a region of interest over a period of time, such as over weeks, months, years, or other periods of time. For instance, meteorological data 142 can include precipitation data, temperature data, wind speed data, air density data, or other types of meteorological data. In certain examples, meteorological data 142 can include comparisons of such data over a period of time, such as a year-over-year comparison of precipitation data for a parcel or region of interest.

Local knowledge data 144 can include information relating to knowledge or preferences specific to a user and may include, for example, preferred agronomic and other crop production practices, site-specific knowledge, past experiences, activities, observations, and outcomes. For instance, local knowledge data 144 can include data that is gathered by a user by walking through the parcel or inspecting the perimeter of the parcel. On some occasions, local knowledge data 144 can be used (e.g., by PVASG 116) to override or modify an aspect of a parcel valuation analysis. On some occasions, local knowledge data 144 can include data received via a social network from other users.

Geographic data 146 can include geographic data (e.g., geographic location data) associated with, for example, land that is included in the determination of the value of the parcel. Examples of geographic data may include location data corresponding to roadways, surface and/or underground water, and landmark locations. Further examples of geographic data 146 can include location data corresponding to resources, such as market locations, labor force locations, equipment locations, and storage locations. Geographic data 146 can be gathered, such as from satellite images, global positioning information, historical information regarding an area of land, plat book service providers, non-governmental and governmental organizations, public and private organizations and agencies, or other sources.

Production history data 148 can include data regarding, for example, the production history of the parcel, such as yield environment and the production history of the parcel under various conditions, such as production yield during relatively wet or rainy years and relatively dry years. It can also include data regarding former crops planted and historical yields, including yield maps illustrating yield variability across the parcel, as-planted maps, and tile maps. Similarly, production history data 148 can include data regarding neighboring fields, such as production and/or historical information corresponding to regions physically proximate a region of interest.

Risk profile data 150 can include information related to risks associated with the land. For example, risk profile data 150 can include the parcel's crop insurance rating as well as other types of insurance ratings, the frequency of insurance claims associated with the parcel, and a frequency of occurrence of severe weather events (e.g., hail, flooding, or extreme wind) that affect a region of interest including a parcel of land.

Premium crop opportunity data 152 can include data that relates to the opportunity to grow profitable, so-called “premium crops” crops such as peas, sugar beets, and sweet corn on the parcel. Premium crops can be considered crops that generally yield higher pecuniary value per acre of land at normal growing conditions relative to other crops that may be grown on the parcel.

Landlord data 154 can include data that relates to obligations and specifications that a landlord may have imposed on the farmer that impact the value of the parcel, such as, for example, easements, restrictions, response requirements, standards, notifications, schedules, requirements, and the like.

Investment profile data 156 can include data regarding the parcel, such as price premiums, emotional attachment, appreciation potential, income potential (return on investment (ROI)), and the cost profile (e.g., improvements required, taxes, etc.)

Soils data 158 can include data related to the soils of the parcel, such as texture, soil variability, organic matter, moisture condition and water-carrying capacity, and fertility.

Drainage data 160 can include data related to the water drainage profile of the parcel, such as potholes, hills present on the parcel, and the slope of the parcel.

Improvements data 162 can include data regarding improvements to the parcel, such as the amount and location of tile (e.g., drainage tile), irrigation, and/or current nutrient levels (reflecting the fertility practices of the current operator).

Logistics data 164 can include data corresponding to the logistics of operating the parcel and/or location of the parcel, such as the proximity of the parcel to other relevant locations, such as other fields managed and farmed by the user. Logistics data 164 can also include data related to additional acreage available, whether operations to be conducted on the parcel can be performed with existing resources, the proximity of the parcel to other parcels, the proximity of the parcel to operational facilities, the proximity of the parcel to harvested crop handling facilities, whether operations on the parcel would expand the planting and/or harvesting season, and whether there are obstacles present to inhibit parcel access (e.g., natural barriers or restrictive easements).

Configuration data 166 can include configuration data associated with the parcel value analysis. For instance, configuration data 166 can include partition parameters which partition the region of interest into a plurality of cells. Configuration data 166 can also include data element weighting factors and threshold values (further described herein) that PVASG 116 can use to determine a parcel value status within a region of interest.

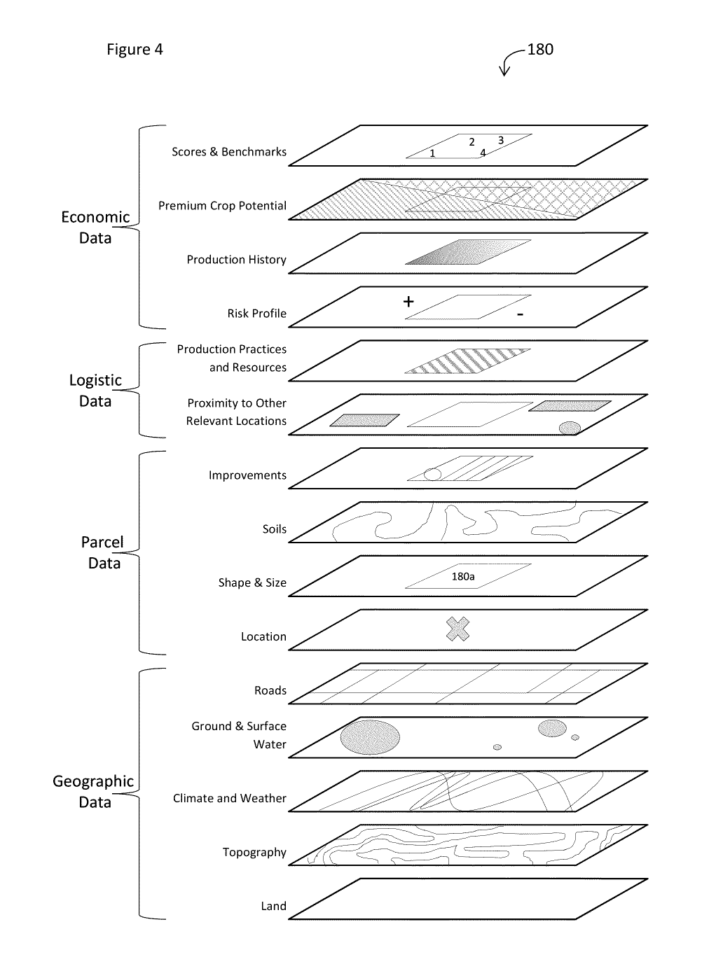

FIG. 4 illustrates an example geographic information system (GIS), in accordance with one or more aspects of this disclosure. As illustrated in FIG. 4, GIS layers image 180 includes multiple data structures, each of which can be regarded as a layer. These layers can provide information regarding various data elements of a parcel valuation analysis, including, for example, geographic data, parcel data, logistic data, and economic data.

Examples of geographic data can include, but are not limited to, information related to an area of land (the parcel plus adjacent areas) (e.g., latitude, longitude, etc.), topography of the region of interest, historical weather and climate information, the presence and location of ground and surface water, and any man-made features upon the land (e.g., buildings, roads, ditches, etc.) currently existing or formerly in existence.

Parcel data can include, in certain examples, data indicative of the location, size, and shape of the parcel, soil attributes (e.g., soil types, texture, organic matter, fertility test results, etc.), and parcel features and improvements (e.g., drain tile).

Non-limiting examples of logistic data can include location data related to the proximity of other relevant fields, structures, and resources, and production practices and operational resources. These practices and resources may include special insights concerning the parcel that may not be generally known to those other than the operator farming the parcel.

Examples of economic data can include, but are not limited to, comparable land values (e.g., price of recently sold parcels, appraisals of comparable parcels, etc.) and comparable land conditions (e.g., relative condition of the parcel when compared with other, similar parcels). Economic data can also include the risk profile of the parcel (e.g., susceptibility to risks) and premium crop potential. Additional examples of economic data can include production history composed of, among other data, former crops planted, previous yields and profits garnered, and local knowledge data. Economic data can also include scores or benchmarks used to perform the parcel valuation analysis. Parcel value analysis data may also include data shared from other farmers, and established parameters, baselines, benchmarks, and scores.

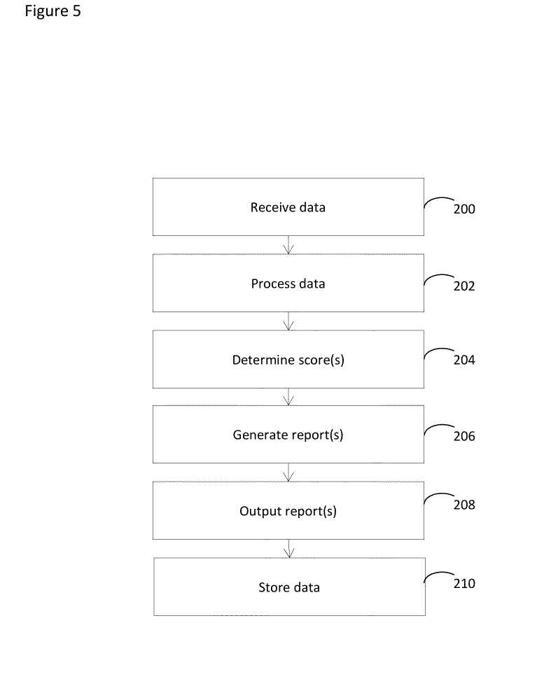

FIG. 5 is a flow diagram illustrating example operations to determine a land value of a parcel of land and automatically output at least one report, in accordance with one or more aspects of this disclosure. For purposes of illustration, the example operations are described below within the context of parcel value analysis and score system 100 and server 104, as shown in FIGS. 1 and 2.

PVASG 116 can receive data for a region of interest (200). The data for the region of interest can include data associated with a parcel of land within the region of interest, such as the data included in database 106. For instance, PVASG 116, executing on one or more processors 120 of server device 104, can receive information from one or more of computing devices 102 (e.g., via user interfaces 114, a social network, etc.), database 106, sensor 108, and data feed 110, such as via communication network 112, point-to-point communications 115, or other such communication methods. Examples of the received data can correspond to one or more factors affecting a value of a parcel of land included in the region of interest, such as one or more previously generated parcel value analyses and/or reports previously generated by PVASG 116 or another computing system and stored in, for example, database 106.

PVASG 116 can process the received data (202). For example, PVASG 116 can partition the region of interest into a plurality of cells (e.g., a grid). Each cell can represent a portion of the region of interest. The portion (e.g., area) of the region of interest that a cell represents can, in certain examples, be determined based on configuration data (e.g., configuration data 166 illustrated in FIG. 3), such as configuration data received by PVASG 116 from one or more of user interfaces 114. In certain examples, PVASG 116 can partition the region of interest to determine the plurality of cells based on one or more default parameters, such as default parameters stored within configuration data 166. In some examples, PVASG 116 can partition the region of interest to determine the plurality of cells based at least in part on one or more parcel value determination accuracy parameters. For instance, by partitioning the region of interest into smaller cell sizes, PVASG 116 can possibly enable more accurate analyses with respect to each cell, and hence, the entire region of interest.

PVASG 116 can determine one or more scores for the region of interest (204). For example, PVASG 116 can determine one or more scores corresponding to a land value within one or more of the plurality of cells and/or corresponding to the entire parcel of land within the region of interest. One or more of the scores can, in some examples, be weighted and/or aggregated according to a priority of a category and/or subcategory associated with the received data, as is further described herein.

PVASG 116 can generate, responsive to determining one or more parcel value scores, at least one report (206). In certain examples, the at least one report can include one or more of an indication of a value of the parcel of land included in the region of interest (e.g., a real estate appraisal corresponding to a monetary market value of the parcel of land), a reason for the report, a date and/or time of a last data sample, a number of cells excluded from the analysis, or other information. In some examples, content of the at least one report can differ based on an identifier of a role of the recipient. For instance, PVASG 116 can output a report to a buyer, seller, or lessee including information that differs from a report that is output to a farmer.

PVASG 116 can output the at least one report (208). For example, PVASG 116 can output the at least one report, via communication network 112, to one or more of computing devices 102 (e.g., via user interfaces 114). In certain examples, PVASG 116 can output the at least one report as one or more of a text message, multi-media service (MMS) message, SMS message, voice message, voicemail message, data file, or other types of messages. In certain examples, PVASG 116 can determine a distribution list that includes one or more accounts associated with the region of interest, and can output the at least one report to each of the accounts included in the list. For instance, the list can include one or more email accounts, telephone numbers, computing device identifiers, and the like, that can, in certain examples, be associated with one or more users. Examples of such users can include, but are not limited to, farmers, agricultural product buyers, agricultural landlords, agricultural bankers, or other such users. In this way, PVASG 116 can output at least one report that can notify one or more users of the parcel value analysis, such as an analysis that includes an indication of a land value of the parcel of land (e.g., a score) included in the region of interest.

PVASG 116 can store data associated with the parcel value score analysis (210). For instance, PVASG 116 can store data (e.g., within database 106) associated with the one or more parameters, scores, received data, or other data. Accordingly, PVASG 116 can use such data during subsequent analyses. That is, the described operations of FIG. 5 can be iterative in nature, such that PVASG 116 receives data, performs operations described with respect to FIG. 5, generates one or more reports and stores data, and uses such stored data in future iterations of the operations. In this way, PVASG 116 can possibly improve the accuracy of subsequent analyses based on prior determinations and iterations of the operations.

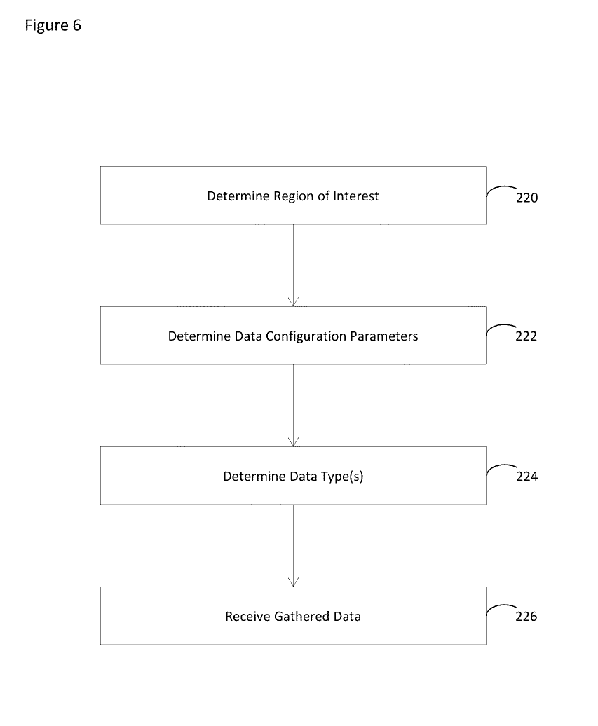

FIG. 6 is a flow diagram illustrating further details of operation 200 as shown in FIG. 5, in accordance with one or more aspects of this disclosure. PVASG 116 can determine a region of interest (220). For instance, PVASG 116 can receive configuration parameters (e.g., via one or more of user interfaces 114) that define the boundaries (e.g., physical boundaries, such as latitude and longitude data) of the region of interest. In some examples, the region of interest can include a parcel of land (e.g., a field of growing crops). In other examples, the region of interest can include one or more portions of a parcel of land (e.g., a portion of a field of growing crops). For instance, a user can define a portion of the parcel of land to be analyzed and/or portions of the parcel that are not to be analyzed. Such portions of a parcel that are not to be analyzed can be referred to as exclusion zones, and can correspond to regions associated with physical features such as build sites, prior build sites, areas of prior manure spills, or other regions that are not to be included in the parcel value determination analysis.

PVASG 116 can determine data configuration parameters corresponding to the region of interest (222). For instance, PVASG 116 can determine the number, size, and/or location of boundaries by which to partition the region of interest to determine a plurality of cells, each of the cells representing a portion of the region of interest. Such cell boundary information can be determined by PVASG 116 (e.g., based on default parameters) and/or received by PVASG 116, such as from one or more of user interfaces 114.

PVASG 116 can determine one or more data types included in the received data for the region of interest (224). As an example, PVASG 116 can receive an indication of the one or more data types from one or more of user interfaces 114. PVASG 116 can receive gathered data for the region of interest (226). For instance, PVASG 116 can receive data for the region of interest from one or more of sensor 108 (e.g., one or more remote sensors, such as an RPV, a satellite, an aircraft, and the like), data feed 110, database 106, and computing devices 102.

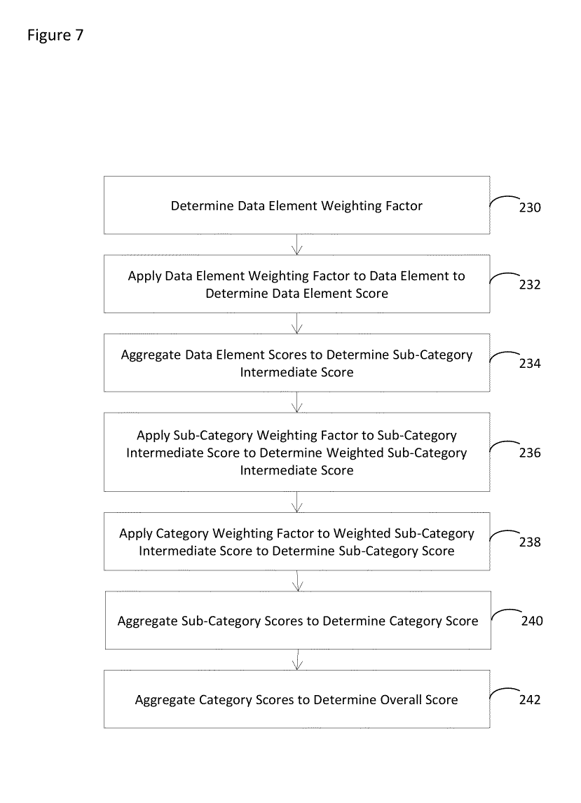

FIG. 7 is a flow diagram illustrating further details of operation 204 as shown in FIG. 5, in accordance with one or more aspects of this disclosure. PVASG 116 can determine a data element weighting factor corresponding to a data element of received data for the region of interest (230). For instance, PVASG 116 can access configuration data (e.g., stored in database 106) to determine a weighting factor associated with the data element, as is further described herein. PVASG 116 can apply the data element weighting factor to the data element to determine a data element score (232). For example, PVASG 116 can multiply a value of the data element by a value of the weighting factor to determine the data element score.

PVASG 116 can aggregate data element scores to determine a sub-category intermediate score (234). For instance, the received data for the region of interest can include one or more categories. Examples of categories can include, but are not limited to, logistics data, shape and size data, soils data, production history data, premium crop opportunities data, improvements data, drainage data, risk profile data, landlord profile data, investment profile data, or other categories of data. At least one of the categories can include one or more sub-categories. For instance, a logistics data category can include one or more sub-categories, such as sub-categories that indicate whether the parcel is included as part of additional acres (e.g., whether there are additional acres that are geographically similar or proximate to the parcel that are also available to be rented or purchased), whether the parcel can be operated with existing resources (e.g., existing machinery, existing irrigation resources, or other resources currently available to a user and/or entity associated with the region of interest), whether the parcel is in proximity to currently operated fields (e.g., agricultural fields currently operated by a user, such as a farmer, or other entity associated with the region of interest), whether the parcel is in proximity to current overall operations (e.g., current agricultural operations of a user and/or entity associated with the region of interest), whether the parcel is in proximity to grain handling facilities, whether the parcel will expand the farmer's planting season, whether the parcel will expand the farmer's harvesting season (e.g., whether the parcel can be planted or harvested within the farmer's current planting or harvesting timeframe and not prolong these typically high-stress times of the year), whether the parcel has unobstructed field access, or other sub-categories. PVASG 116 can aggregate the data element scores within sub-categories to determine sub-category intermediate scores for the sub-categories. As one example, PVASG 116 can aggregate the data element scores by summing the data element scores. In other examples, PVASG 116 can aggregate the data element scores by multiplying, averaging, or by using other aggregation techniques.

PVASG 116 can apply a sub-category weighting factor to the sub-category intermediate score to determine a weighted sub-category intermediate score (236). PVASG 116 can apply a category weighting factor to the weighted sub-category intermediate score to determine a sub-category score (238). PVASG 116 can aggregate sub-category scores to determine a category score (240). PVASG 116 can aggregate category scores to determine an overall score (242). PVASG 116 can determine the overall score with respect to an entire region of interest, a portion of the region of interest (e.g., a cell), or both.

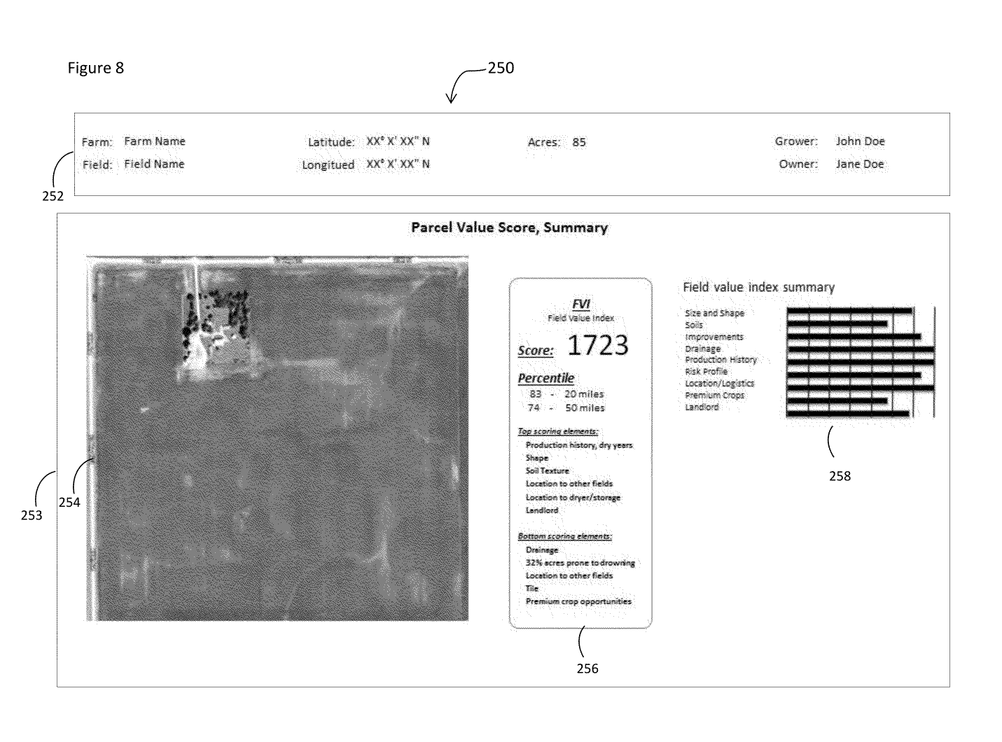

FIG. 8 depicts an example parcel valuation report 250 that includes data regarding the valuation of a particular parcel of land. It should be appreciated that the data depicted in report 250 is merely an example, and any single, combination, or sub-combination of parcel valuation factors may be considered when determining a value of a parcel or a trend in the value of the parcel.

As illustrated, parcel valuation report 250 can include parcel summary information 252, such as one or more of a farm name, a parcel name, latitude and longitude coordinates of the parcel, a total acreage of the parcel, a grower name, and an owner name of the parcel. Parcel valuation report 250 can also include partial valuation score summary 253, which, in turn, can include one or more images 254 of the parcel, parcel value index 256, and parcel value index summary 258. Parcel value index 256 can include, for example, the overall score for the parcel, a relative percentile for the score relative to other parcels of land within a threshold geographic radius of the parcel (e.g., five miles, twenty miles, fifty miles, or other distances), a list of top scoring elements associated with the parcel, and/or a list of bottom scoring elements associated with the parcel. Parcel value index summary 258 can include a graphical and/or other summary depiction of scores associated with the parcel for various categories of data.

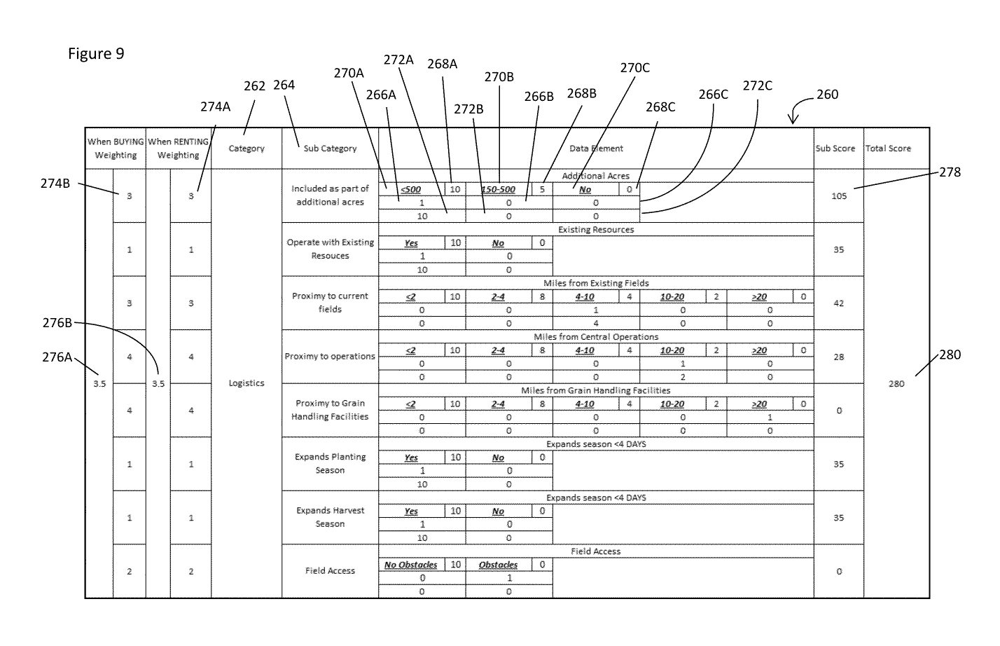

FIG. 9 illustrates a table 260 that represents an example scoring matrix for use in a method of determining a land value of a parcel of land within a region of interest, in accordance with one or more aspects of this disclosure. As illustrated in FIG. 9, table 260 can include category 262 of received data for a region of interest. However, while illustrated with respect to one category, in certain examples, table 260 can include a plurality of categories, such as two categories, three categories, ten categories, or other numbers of categories. In the illustrated example, category 262 corresponds to logistics data. Other example categories can include, but are not limited to, shape and size data, soils data, production history data, premium crop opportunities data, improvements data, drainage data, risk profile data, landlord profile data, investment profile data, or other categories of data.

As further illustrated in FIG. 9, category 262 (e.g., logistics data in this example) can include sub-categories 264, including, in this example, categories indicating whether the parcel is included as part of additional acres, whether the parcel can be operated with existing resources, proximity of the parcel to currently operated fields, proximity of the parcel to current overall operations, proximity of the parcel to grain handling facilities, whether the parcel will expand the farmer's planting season, whether the parcel will expand the farmer's harvesting season, whether the parcel has unobstructed field access, or other sub-categories. In certain examples, sub-categories 264 can include more or fewer sub-categories. In general, sub-categories 264 can include any number of sub-categories (e.g., zero, one, two, five, fifty, or other numbers of sub-categories) that are deemed relevant to a category of data.

PVASG 116 can classify received data for the region of interest according to a sub-category and/or category. Received data can take the form of a data element, such as data elements 266A-266C. PVASG 116 can determine a data element weighting factor for each of the one or more data elements, such as data element weighting factors 268A-268C. In some examples, PVASG 116 can determine the data element weighting factors for each of the one or more data elements based on a comparison of the data element to one or more threshold values. For instance, as illustrated in FIG. 9, PVASG 116 can determine that data element weighting factor 268A is to be applied to data element 266A based on a comparison of data element 266A with threshold value 270A. Similarly, PVASG 116 can determine that data element weighting factor 268B is to be applied to data element 266B based on a comparison of data element 266B with threshold values 270B (i.e., a range of threshold values). PVASG 116 can determine that data element weighting factor 268C is to be applied to data element 266C based on a comparison of data element 266C with threshold value 270C. In this way, as illustrated in FIG. 9, PVASG 116 can determine a plurality of data element weighting factors to be applied to a plurality of data elements corresponding to a plurality of sub-categories within the category. Similarly, PVASG 116 can determine such data element weighting factors for a plurality of sub-categories within a plurality of categories.

PVASG 116 can apply the determined data element weighting factors (e.g., data element weighting factors 268A-268C) to the data elements (e.g., data elements 266A-266C) to determine a plurality of data element scores, such as data element scores 272A-272C. For example, PVASG 116 can multiply data element 266A by weighting factor 268A to determine data element score 272A. Similarly, PVASG 116 can multiply data element 266B by weighting factor 268B to determine data element score 272B, and can multiply data element 266C by weighting factor 268C to determine data element score 272C.

PVASG 116 can aggregate (e.g., sum, multiply, average, and the like) the data element scores (e.g., data element scores 272A-272C) to determine a sub-category sub-score. For instance, PVASG 116 can sum data element scores 272A-272C to determine the sub-category sub-score (e.g., summing by the equation “10+0+0” to determine a sub-score of “10”). PVASG 116 can apply a sub-category weighting factor, such as sub-category weighting factor 274B (for determining a score using a weighting system associated with a purchase of a parcel of land) or sub-category weighting factor 274A (for determining a score using a weighting system associated with rental of a parcel of land) to determine a sub-category intermediate score. For instance PVASG 116 can multiply sub-category weighting factor 274B by the determined sub-category sub-score (e.g., “10” in this example) to determine a sub-category intermediate score (e.g., “30” in this example). PVASG 116 can apply (e.g., multiply) a category weighting factor, such as category weighting factor 276A (for determining a score using a weighting system associated with a purchase of a parcel of land) or category weighting factor 276B (for determining a score using a weighting system associated with rental of a parcel of land), to the determined sub-category intermediate score to determine a sub-category score for the sub-category. For instance, PVASG 116 can multiply category weighting factor 276B (e.g., “3.5” in this example) by the determined sub-category intermediate score (e.g., “30” in this example) to determine subcategory score 278 (e.g., “105” in this example). As illustrated, PVASG 116 can determine a plurality of sub-category scores for a plurality of sub-categories. PVASG 116 can aggregate the sub-category scores to determine a category score, such as category score 280. In some examples, PVASG 116 can aggregate a plurality of determined category scores to determine an overall score. For instance, PVASG 116 can determine an overall score (e.g., for a portion of a region of interest such as a cell, for the entire region of interest, or for other areas) as the sum of a plurality of determined category scores.

Each of the above-described weighting factors (i.e., data element weighting factors, sub-category weighting factors, and category weighting factors) can be different or the same. In addition, each of the weighting factors can be modified, such as automatically by PVASG 116 and/or in response to input received from one or more of user interfaces 114. For instance, a user can modify one or more of the weighting factors, such as by providing user input via one or more of user interfaces 114 to adjust a weighting factor and/or provide a new value for the weighting factor. The scoring matrix represented by table 260 can be associated with a portion of a region of interest (e.g., a cell), an entire region of interest (e.g., a field), or both.

Accordingly, PVASG 116 can determine a land value of a parcel of land included in a region of interest at a level of granularity based on a size of a cell of the region of interest, or for the region of interest as a whole. PVASG 116 and/or a user (e.g., via user interfaces 114) can modify one or more of the parameters and/or the weighting factors, thereby modifying a level of sensitivity of the generation of reports and/or a contribution of one or more forms of data to the generation of reports.

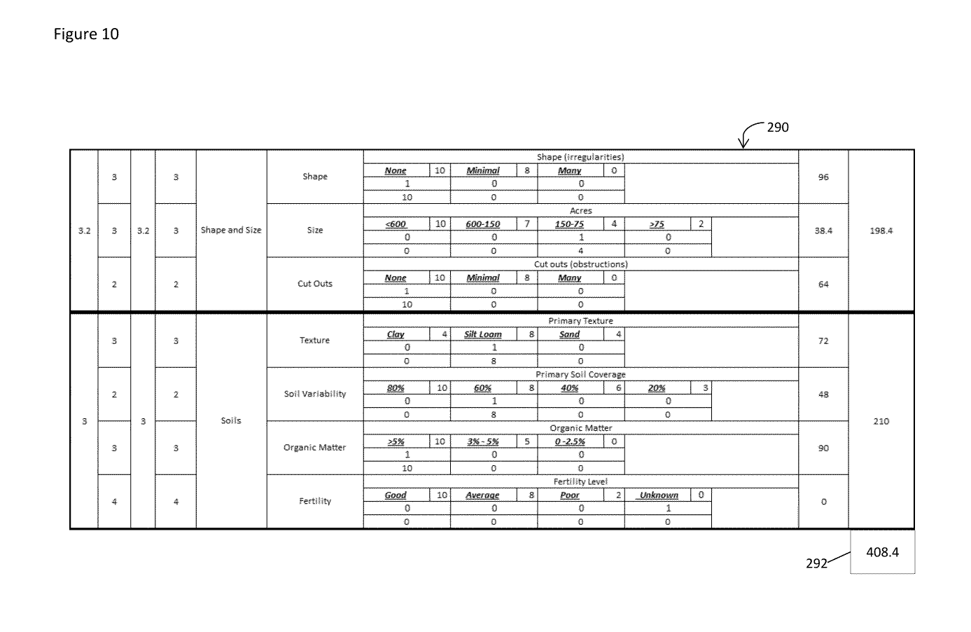

FIG. 10 illustrates table 290 that represents an example scoring matrix for use in a method of determining a land value of a parcel of land within a region of interest, in accordance with one or more aspects of this disclosure. Specifically, FIG. 10 illustrates table 290 that represents an example scoring matrix with respect to different (i.e., as compared to table 260 of FIG. 9) categories and sub-categories of data. As illustrated in FIG. 10, PVASG 116 can receive data for the categories of shape and size data and soils data. The shape and size data category can include a plurality of sub-categories, such as sub-categories corresponding to the shape, size, and cut outs (exclusions from the data set) of the parcel. The soils data category can include a plurality of sub-categories, such as sub-categories corresponding to the texture, soil variability, organic matter, and fertility of the soils in the region of interest. As illustrated, PVASG 116 can determine one or more data element weighting factors and apply the determined data element weighting factors to the data elements to determine one or more data element scores. PVASG 116 can aggregate the one or more data element scores within a sub-category to determine a sub-category sub-score. PVASG 116 can apply a sub-category weighting factor to the sub-category sub-score to determine a sub-category intermediate score, and can apply a category weighting factor to the sub-category intermediate score to determine a sub-category score. PVASG 116 can aggregate the sub-category scores to determine one or more category scores. In some examples, PVASG 116 can aggregate the category scores to determine overall score 292, such as an overall score for a portion of a region of interest (e.g., a cell) and/or the entire region of interest.

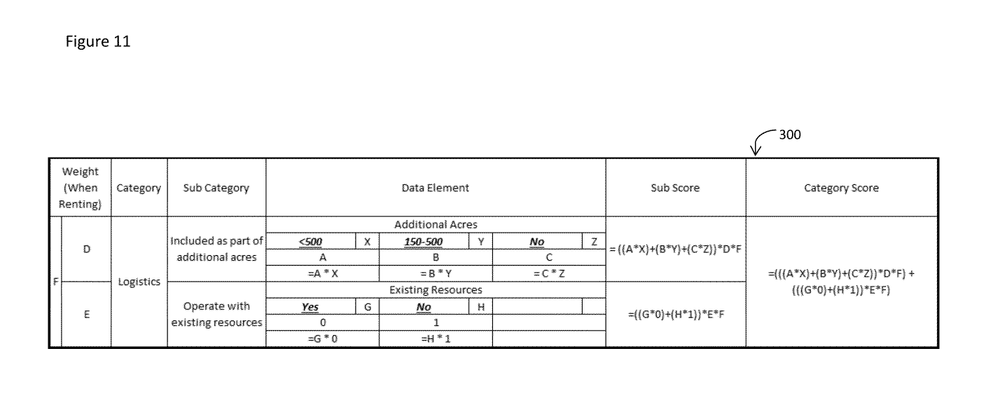

FIG. 11 illustrates table 300 that represents example calculations that can be used to determine a land value of a parcel of land within a region of interest, in accordance with one or more aspects of this disclosure. Specifically, table 300 further illustrates example calculations as described above with respect to FIG. 9 that can be used to determine data element scores, sub-category scores, and a category score.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method comprising:
receiving, by a parcel value analyzer and score generator (PVASG) executing on a computing device, data for a region of interest that includes a parcel of land, wherein the data for the region of interest comprises at least one of parcel data and logistics data;
determining, by the PVASG and based on the received data for the region of interest, a land value for the parcel of land included in the region of interest; and
outputting, by the PVASG and in response to determining the land value for the parcel of land included in the region of interest, at least one report that includes an indication of the determined land value for the parcel of land.

2. The method of claim 1, wherein the parcel data comprises data corresponding to at least one of a location of the parcel of land, a size of the parcel of land, topographical information of the parcel of land, and crop conditions of growing crops included in the parcel of land.

3. The method of claim 1, wherein the logistics data comprises data corresponding to at least one of proximity of the parcel of land to other locations, whether operations to be conducted on the parcel of land can be performed with existing resources, proximity of the parcel of land to operational facilities, proximity of the parcel of land to crop handling facilities, and whether access to the parcel of land is inhibited.

4. The method of claim 1, wherein the land value for the parcel of land reflects a monetary market value of the parcel of land.

5. The method of claim 1, wherein the land value for the parcel of land comprises a score that reflects a comparison of the data for the region of interest with one or more parameters.

6. The method of claim 1,
wherein the parcel of land comprises a first parcel of land,
wherein determining the land value for the parcel of land included in the region of interest comprises determining a first land value for the first parcel of land, and
wherein the first land value for the first parcel of land reflects a comparison of the first land value for the first parcel of land with a second land value for a second, different parcel of land.

7. The method of claim 1, wherein the at least one report includes a parcel value index that comprises an overall score for the parcel of land and a relative percentile for the overall score relative to other parcels of land within a threshold geographic radius of the parcel.

8. The method of claim 1, wherein the region of interest comprises a plurality of cells, and wherein determining the land value of the parcel of land included in the region of interest comprises:
determining, by the PVASG, a parcel value score for at least one cell from the plurality of cells; and
determining, by the PVASG, the land value for the parcel of land included in the region of interest based on the parcel value score for the at least one cell from the plurality of cells.

9. The method of claim 8, wherein determining the land value for the parcel of land included in the region of interest based on the parcel value score for the at least one cell comprises:
aggregating, by the PVASG, the parcel value score for each of the at least one cell from the plurality of cells to determine a land value score for the parcel of land included in the region of interest; and
determining, by the PVASG, the land value for the parcel of land based on the land value score for the parcel of land.

10. The method of claim 8, wherein the data for the region of interest comprises one or more categories, and wherein determining the land value for the parcel of land included in the region of interest comprises:
determining, by the PVASG, a category score for each of the one or more categories to determine one or more category scores for the at least one cell; and
aggregating, by the PVASG, the one or more category scores to determine the parcel value score for the at least one cell.

11. The method of claim 10, wherein determining the one or more category scores for the at least one cell further comprises:
applying, by the PVASG, a category weighting factor to each of the one or more category scores to determine the one or more category scores for the at least one cell.

12. The method of claim 11, wherein applying the category weighting factor to each of the one or more category scores comprises:
applying, by the PVASG, a first category weighting factor to a first one of the one or more category scores to determine a first category score for the at least one cell; and
applying, by the PVASG, a second category weighting factor to a second one of the one or more category scores to determine a second category score for the at least one cell,
wherein the second category weighting factor is different than the first category weighting factor.

13. The method of claim 10, wherein at least one of the one or more categories for the at least one cell comprises one or more sub-categories, and wherein determining the one or more category scores for the at least one cell comprises:
determining, by the PVASG, a sub-category score for each of the one or more sub-categories to determine one or more sub-category scores for the one or more categories; and
aggregating, by the PVASG, the one or more sub-category scores to determine the one or more category scores for the at least one cell.

14. The method of claim 13, wherein determining the one or more sub-category scores for the one or more categories further comprises:
applying, by the PVASG, a sub-category weighting factor to each of the one or more sub-category scores to determine one or more sub-category intermediate scores; and
applying, by the PVASG, the category weighting factor to the one or more sub-category intermediate scores to determine the one or more sub-category scores.

15. The method of claim 14, wherein applying the sub-category weighting factor to each of the one or more sub-category scores to determine the one or more sub-category intermediate scores comprises:
applying, by the PVASG, a first sub-category weighting factor to a first one of the one or more sub-category scores to determine a first sub-category intermediate score; and
applying, by the PVASG, a second sub-category weighting factor to a second one of the one or more sub-category scores to determine a second sub-category intermediate score,
wherein the second sub-category weighting factor is different than the first sub-category weighting factor.

16. The method of claim 13, wherein at least one of the one or more sub-categories comprises one or more data elements, and wherein determining the one or more sub-category scores for the one or more categories comprise:
determining, by the PVASG, a data element score for each of the one or more data elements to determine one or more data element scores for the one or more sub-categories; and
aggregating, by the PVASG, the one or more data element scores to determine the one or more sub-category scores for the one or more categories.

17. The method of claim 16, wherein determining the one or more data element scores for the one or more sub-categories further comprises:
determining, by the PVASG, a data element weighting factor for each of the one or more data elements; and
applying, by the PVASG, the data element weighting factor to each of the one or more data elements to determine the one or more data element scores.

18. The method of claim 17, wherein applying the data element weighting factor to each of the one or more data element scores to determine the one or more data element scores for the one or more sub-categories comprises:
applying, by the PVASG, a first data element weighting factor to a first one of the one or more data element scores to determine a first data element score for the one or more sub-categories; and
applying, by the PVASG, a second data element weighting factor to a second one of the one or more data element scores to determine a second data element score for the one or more sub-categories,
wherein the second data element weighting factor is different than the first data element weighting factor.

19. The method of claim 1, further comprising receiving, by the PVASG and from a user interface communicatively coupled to the computing device, one or more parameters corresponding to the land value for the parcel of land, wherein determining the land value for parcel of land comprises determining the land value for the parcel of land based on a comparison of the received data for the region of interest with the one or more parameters.

20. A system comprising:
a computing device comprising at least one processor; and
a parcel value analyzer and score generator (PVASG) executable by the at least one processor of the computing device and configured to:
receive data for a region of interest that includes a parcel of land, wherein the data for the region of interest comprises at least one of parcel data and logistics data;
determine, based on the received data for the region of interest, a land value for the parcel of land included in the region of interest; and
output, in response to determining the land value for the parcel of land included in the region of interest, at least one report that includes an indication of the determined land value for the parcel of land.

21. The system of claim 20, wherein the parcel data comprises data corresponding to at least one of a location of the parcel of land, a size of the parcel of land, topographical information of the parcel of land, and crop conditions of growing crops included in the parcel of land.

22. The system of claim 20, wherein the logistics data comprises data corresponding to at least one of proximity of the parcel of land to other locations, whether operations to be conducted on the parcel of land can be performed with existing resources, proximity of the parcel of land to operational facilities, proximity of the parcel of land to grain handling facilities, and whether access to the parcel of land is inhibited.

23. The system of claim 20, wherein the land value for the parcel of land reflects a monetary market value of the parcel of land.

24. The system of claim 20, wherein the land value for the parcel of land comprises a score that reflects a comparison of the data for the region of interest with one or more parameters.

25. The system of claim 20,
wherein the parcel of land comprises a first parcel of land,
wherein the PVASG is configured to determine the land value for the parcel of land included in the region of interest by at least being configured to determine a first land value for the first parcel of land, and
wherein the first land value for the first parcel of land reflects a comparison of the first land value for the first parcel of land with a second land value for a second, different parcel of land.

26. The system of claim 20, wherein the at least one report includes a parcel value index that comprises an overall score for the parcel of land and a relative percentile for the overall score relative to other parcels of land within a threshold geographic radius of the parcel.

27. The system of claim 20, wherein the region of interest comprises a plurality of cells, and wherein the PVASG is configured to determine the land value of the parcel of land included in the region of interest by at least being configured to:
determine a parcel value score for at least one cell from the plurality of cells; and
determine the land value for the parcel of land included in the region of interest based on the parcel value score for the at least one cell from the plurality of cells.

28. The system of claim 27, wherein the PVASG is configured to determine the land value for the parcel of land included in the region of interest based on the parcel value score for the at least one cell by at least being configured to:
aggregate the parcel value score for each of the at least one cell from the plurality of cells to determine a land value score for the parcel of land included in the region of interest; and
determine the land value for the parcel of land based on the land value score for the parcel of land.

29. A computer-readable storage medium encoded with instructions that, when executed, cause at least one processor of a computing device to:
receive data for a region of interest that includes a parcel of land, wherein the data for the region of interest comprises at least one of parcel data and logistics data;
determine, based on the received data for the region of interest, a land value for the parcel of land included in the region of interest; and
output, in response to determining the land value for the parcel of land included in the region of interest, at least one report that includes an indication of the determined land value for the parcel of land.

30. A method comprising:
receiving, by a parcel value analyzer and score generator (PVASG) executing on a computing device, data associated with a parcel of land, wherein the data associated with the parcel of land comprises at least one of parcel data and logistics data;
determining, by the PVASG and based on the received data associated with the parcel of land, a real estate appraisal for the parcel of land; and
outputting, by the PVASG and in response to determining the real estate appraisal for the parcel of land, at least one report that includes an indication of the determined real estate appraisal for the parcel of land.

31. A method comprising:
receiving, by a parcel value analyzer and score generator (PVASG) executing on a computing device, data for a region of interest that includes real estate, wherein the data for the region of interest comprises non-pecuniary data;
assigning, by the PVASG, a pecuniary value to the non-pecuniary data using a weighting of one or more factors associated with the non-pecuniary data; and
outputting, by the PVASG, at least one report that includes an indication of the pecuniary value for the real estate.
